(19) United States
(12) Patent Application Publication
(10) Pub. No.: US 2020/0223135 A1
(43) Pub. Date: Jul. 16, 2020

(54) ADDITIVELY MANUFACTURED COMPONENTS HAVING A NON-PLANAR INCLUSION

(71) Applicant: Apple Inc., Cupertino, CA (US)

(72) Inventors: Alison B. Shutzberg, Atlanta, GA (US); Suzanne C. Brown, San Jose, CA (US); Christopher Wilk, Los Gatos, CA (US); Anthony P. Grazian, Los Gatos, CA (US)

(21) Appl. No.: 16/245,136

(22) Filed: Jan. 10, 2019

(51) Int. Cl. B29C 64/245; B29C 64/255; B28B 11/24

(52) U.S. Cl. CPC B29C 64/245; B33Y 30/00; B28B 11/24; B29C 64/255

(57) ABSTRACT

An additively manufactured component has an additively manufactured substrate and an inclusion. The substrate has a first region and a second region defining a first contour and a second contour, respectively. One or both of the first contour and the second contour is non-planar. The inclusion is positioned between the first region and the second region. The inclusion has a first major surface conforming to the first contour. The inclusion also has a second major surface. The second major surface can conform to the second contour. The inclusion can be a cavity, and the substrate can enclose the cavity or the cavity can be in open communication with an environment surrounding the substrate. The inclusion can be a member or an assembly of plural members. Modules and electronic devices incorporating an additively manufactured component also are described.

### FIELD

This application and related subject matter (collectively referred to as the “disclosure”) generally concern additively manufactured components having a non-planar inclusion, together with associated methods for producing such components, as well as systems including such components.

### BACKGROUND INFORMATION

Historically, discrete components have been fabricated by subtractive-manufacturing processes, formative-manufacturing processes, or a combination thereof. A subtractive-manufacturing process generally involves removing one or more selected regions of material from a given mass of material to produce a component having a desired geometry. A formative-manufacturing process, on the other hand, generally involves deformation of a material to produce a component having a desired geometry.

Additive-manufacturing processes involve selectively accreting material to produce a desired component, as by successively accumulating incremental units of material to define a unitary construct having a desired configuration. ISO/ASTM Standard 52900, 2015, published by ASTM International (formerly known as the American Society for Testing and Materials), defines “additive-manufacturing” as the “process of joining materials to make parts from 3D model data, usually layer upon layer, as opposed to subtractive manufacturing and formative manufacturing methodologies.” Conceptually, additive-manufacturing can be considered as being an opposite of a subtractive process insofar as material is accreted or otherwise selectively accumulated in an additive process. By contrast, material is incrementally removed from a given mass of material in a subtractive process. That being said, physical principles employed in additive-manufacturing may be (and usually are) unrelated to physical principles employed in subtractive manufacturing.

### SUMMARY

Additive manufacturing processes and additively manufactured components described herein overcome one or more deficiencies present in the current state of the additive-manufacturing art. More particularly, but not exclusively, disclosed additive-manufacturing processes are capable of fabricating components with one or more non-planar inclusions. As used herein, the term “inclusion” means “a body, recess, or particle recognizably distinct from the substrate in which it is embedded or encased.” In addition to other advantages, disclosed components and processes can shorten the time between designing a component and obtaining a prototype of the component. For example, disclosed processes can produce prototypes that approximate or provide qualities of production parts. Accordingly, disclosed components can be functional prototypes (e.g., parts having electrical connections or enhanced structural integrity). In certain embodiments, disclosed processes can be used to fabricate mass-produced parts, and some disclosed components are mass-produced components. Therefore, disclosed processes and components are not limited to prototypes or low-volume parts.

According to a first aspect, an additively manufactured component includes an additively manufactured substrate and an inclusion positioned within the substrate. The substrate has a first region defining a corresponding first internal contour and a second region defining a corresponding second internal contour. One or both of the first internal contour and the second internal contour is non-planar. The inclusion is positioned between the first region and the second region. The inclusion has a first major surface and a second major surface. The first major surface of the inclusion can conform to the first internal contour of the substrate and the second major surface of the inclusion can conform to the second internal contour of the substrate.

The substrate can be a unitary construct including the first region and the second region. In an embodiment, the unitary construct comprises a homogeneous material spanning from the first region to the second region.

The additively manufactured substrate can have an isotropic material strength spanning from the first region to the second region.

The additively manufactured substrate can include a homogeneous material spanning from the first region to the second region. In an embodiment, the homogeneous material has an anisotropic material strength.

In an embodiment, the inclusion comprises a cavity positioned within the substrate. The substrate can enclose the cavity, as by sealing the cavity. In another embodiment, the substrate can define an external surface and a channel extending from the external surface of the substrate to the cavity.

The inclusion can include a member positioned within and at least partially retained by the additively manufactured substrate. In an embodiment, the additively manufactured substrate encapsulates at least a portion of the member.

The substrate can define an external surface and the inclusion can include a metal member having a first portion and a second portion. The substrate can encapsulate the first portion and expose the second portion at the external surface of the substrate.

In an embodiment, the inclusion comprises a first member and a second member. For example, the first member can include a formatively manufactured metal member, and the second member can include a non-metal member.

According to an aspect, an electronic device can include an enclosure, a processor, and a memory. The memory stores instructions executable by the processor. The electronic device also includes an additively manufactured substrate positioned within the enclosure. A first region of the substrate defines a corresponding first internal contour and a second region of the substrate defines a corresponding second internal contour. One or both of the first internal contour and the second internal contour is non-planar. The substrate has an inclusion positioned between the first region and the second region, and the inclusion has a first major surface and a second major surface. The first major surface conforms to the first internal contour and the second major surface conforms to the second internal contour.

In an embodiment, the substrate is a unitary construct including the first region and the second region. For example, the unitary construct can include a homogeneous material spanning from the first region to the second region.

The additively manufactured substrate can include a material having an isotropic material strength.

In an embodiment, the additively manufactured substrate includes a homogeneous material. The homogeneous material can have an anisotropic material strength.

In an embodiment, the inclusion can be a cavity positioned within the substrate. The substrate can enclose the cavity. In an embodiment, the substrate defines an external surface and a channel extending from the external surface of the substrate to the cavity.

In an embodiment, the inclusion includes a member positioned within and at least partially retained by the additively manufactured substrate. For example, the additively manufactured substrate can encapsulate at least a portion of the member.

The substrate can define an external surface and the inclusion can include a metal member having a first portion and a second portion. The substrate can encapsulate the first portion and can expose the second portion at the external surface of the substrate.

In an embodiment, the inclusion includes a first member and a second member. The first member can include a formatively manufactured metal member, and the second member can include a non-metal member.

In an embodiment, the electronic device further includes an electro-acoustic transducer having a diaphragm. The additively manufactured substrate can be a portion of the diaphragm and the inclusion can be a metal component. In such an embodiment, the instructions, when executed by the processor, can cause the electronic device to induce oscillatory movement of the diaphragm.

In an embodiment, the inclusion is a metal-stamped electrical connection or screw tab embedded in the additively manufactured substrate.

The foregoing and other features and advantages will become more apparent from the following detailed description, which proceeds with reference to the accompanying drawings.

### BRIEF DESCRIPTION OF THE DRAWINGS

Referring to the drawings, wherein like numerals refer to like parts throughout the several views and this specification, aspects of presently disclosed principles are illustrated by way of example, and not by way of limitation.

FIGS. 1A through 1D illustrate intermediate constructs in cross-section during an additive-manufacturing process.

FIG. 1E illustrates a cross-sectional view of an additively manufactured component having an inclusion positioned within an additively manufactured substrate fabricated with a process described in relation to FIGS. 1A through 1D.

FIG. 1F illustrates an intermediate construct having a non-planar surface defining a curved contour. The intermediate construct shown in FIG. 1F is an alternative to the intermediate construct shown in FIG. 1A.

FIGS. 2A though 2D illustrate intermediate constructs in cross-section during another additive-manufacturing process.

FIG. 2E illustrates a cross-sectional view of another additively manufactured component having an inclusion positioned within an additively manufactured substrate fabricated with a process described in relation to FIGS. 2A through 2D.

FIGS. 3A though 3E illustrate intermediate constructs in cross-section during yet another additive-manufacturing process.

FIG. 3F illustrates a cross-sectional view of another additively manufactured component having an inclusion positioned within an additively manufactured substrate fabricated with a process described in relation to FIGS. 3A through 3E.

FIG. 3G illustrates a cross-sectional view of an intermediate construct as in FIG. 3B. In FIG. 3G, however, a portion of the inclusion extends beyond an outer surface of the additively manufactured substrate.

FIG. 3H illustrates a cross-sectional view of an additively manufactured component having a portion of an inclusion positioned within an additively manufactured substrate and another portion extending beyond an outer surface of the substrate fabricated with a process described in relation to FIGS. 3A, 3G, and 3C through 3E.

FIGS. 4A through 4D illustrate intermediate constructs in cross-section during still yet another additive-manufacturing process. Each cross-section is taken along the respective section line shown in FIGS. 5A through 5D.

FIG. 4E illustrates a cross-sectional view of an additively manufactured component having an inclusion positioned in an additively manufactured substrate fabricated with a process described in relation to FIGS. 4A through 4D.

FIG. 4F illustrates a cross-sectional view of an additively manufactured component as in FIG. 4E, except that a portion of the inclusion shown in FIG. 4F extends beyond an outer surface of the additively manufactured substrate.

FIGS. 5A through 5D illustrate regions of a photoreactive polymeric resin illuminated during the additive-manufacturing process depicted in FIGS. 4A through 4D, respectively.

FIGS. 6A through 6D illustrate intermediate constructs in cross-section during an additive-manufacturing process.

FIGS. 7A through 7C illustrate intermediate constructs in cross-section during a known additive-manufacturing process.

FIG. 8 illustrates a schematic block diagram of an audio appliance incorporating an additively manufactured component.

### DETAILED DESCRIPTION

The following describes various principles related to additive-manufacturing and additively manufactured components, as well as electronic devices and related systems incorporating such components. For example, some disclosed principles pertain to methods for additively manufacturing a substrate with an inclusion therein, and some disclosed principles pertain to additively manufactured components, as well as to electronic devices and other systems incorporating such components. An inclusion can be a cavity or a functional member, or a combination thereof. The functional member can be configured to provide a desired function, such as, for example, a signal-carrying function, a current-carrying function, a grounding function, an electro-magnetic function (e.g., as a voice-coil), a permanent magnetic function, a structural function, an acoustic-damping function, or a combination thereof. For example, an inclusion configured as a functional member can include a metal region, a polymer region, a composite region, and a combination thereof. An inclusion, or a constituent region thereof, may have a planar or a non-planar contour mating with, seated against, or otherwise contacting an additively manufactured portion of a substrate.

To illustrate certain principles, selected additive-manufacturing processes, additively manufactured components, and related devices and systems are described. That being said, descriptions herein of specific component, device or system configurations, and specific combinations of method acts, are just particular examples of contemplated component, device and system configurations, and method combinations, chosen as being convenient to illustrate disclosed principles. One or more of the disclosed principles can be incorporated in various other component, device or system configurations, and method combinations, to achieve any of a variety of corresponding, desired characteristics. Thus, a person of ordinary skill in the art, following a review of this disclosure, will appreciate that combinations having attributes that are different from those specific examples discussed herein can embody one or more presently disclosed principles, and can be used in applications not described herein in detail. Such alternative embodiments also fall within the scope of this disclosure.

### I. OVERVIEW

Many components of modern electronic devices are manufactured using subtractive-manufacturing and formative-manufacturing techniques. And, many components of modern electronic devices include integrated combinations of constituent parts. Further, such constituent parts may be made of different materials, as to achieve one or more corresponding functional or performance characteristics.

For example, a so-called “micro-speaker” or other electro-acoustic transducer may include a diaphragm (or other acoustic radiator) physically connected with a voice coil (e.g., a wire formed of copper clad aluminum wrapped around, for example, a bobbin). The voice coil can be positioned adjacent a permanent magnet having a corresponding magnetic field, and an electrical current passing through the voice coil can induce a magnetic field around the coil. A resultant force as between the magnetic field emanating from the coil and the magnetic field of the magnet can urge the coil (and by extension the diaphragm) into motion. With such an arrangement, the diaphragm can be driven to oscillate, and thus emit sound, at selected frequencies by selectively varying the electrical current passing through the voice coil.

Certain components of electro-acoustic transducers (including “micro-speakers” and other loudspeakers) can be fabricated by insert-molding, a formative manufacturing process. For example, a diaphragm may be insert-molded using a stiff and light material to reduce physical deformation and inertial effects that otherwise might introduce acoustic distortion. And, the insert-molded diaphragm may also include an integrated weld pad (or other electrical interconnection) to which the voice-coil may be welded or otherwise physically or electrically coupled. The weld pad may include a step, boss, shoulder, or other non-planar feature around which the diaphragm material can cure or harden, anchoring the weld pad relative to the diaphragm. As well, such a weld pad may include a step or other non-planar feature to convey an electrical current or signal from a first planar elevation to a second (e.g., different) planar elevation within or through an overlying substrate.

In an insert-molding process, a constituent component (e.g., the weld pad) can be positioned wholly or partially within a mold cavity and a substrate material (e.g., molten or softened plastic) can be injected into the cavity, covering one or more regions of the constituent component exposed to the cavity. The constituent component may include a step, boss, shoulder, or other non-planar feature around which the substrate material can cure or harden, anchoring the constituent component in or to the formatively-manufactured substrate. With such anchoring, an adhesive or other bonding agent may not be needed to provide purchase between the constituent component and the substrate. Accordingly, a non-planar region of a weld pad (or other electrical interconnection) can be at least partially embedded in a region of, e.g., a plastic, diaphragm.

Nonetheless, certain part configurations are difficult or impossible to fabricate using insert-molding (or other formative or subtractive) processes. Additionally, insert-molding and other formative processes impose delay between design conception and fabrication, as molds or other forming tools must first be built to fabricate a newly designed component.

For example, in an injection-molding or an insert-molding process, a mold (often involving two or more constituent dies) corresponding to even a simple part must be designed, typically after the primary part has been designed. Each constituent die subsequently is fabricated, e.g., using a subtractive process. Next, the constituent dies are assembled and an injectable material (e.g., molten plastic) is urged into a cavity within the assembled mold. Once the injected material hardens, the mold is disassembled and the part is removed from the mold for subsequent processing (e.g., to remove carrier tabs, assemble with other parts, etc.). More complex parts (e.g., involving a deep recess, an undercut, or an included cavity) typically are decomposed into constituent components that can be assembled or otherwise joined together after being fabricated.

Such decomposition and subsequent assembly or other joining can be reduced or eliminated when using an additive-manufacturing process, as certain additive-manufacturing processes can quickly produce individual parts having relatively complex geometries. Nonetheless, previously known additive-manufacturing processes have been limited generally to producing individual components formed of homogeneous materials or materials having smoothly varying bulk properties.

Unlike known additive-manufacturing processes, disclosed additive-manufacturing processes can fabricate a component having one or more non-planar inclusions. For example, a disclosed additive-manufacturing process can produce parts having a non-flat constituent component (e.g., a weld pad) or another inclusion wholly or partially positioned within a surrounding substrate (e.g., a micro-speaker diaphragm).

Moreover, certain additive-manufacturing processes can rapidly fabricate newly developed designs. For example, an additive-manufacturing process can directly fabricate a simple or a complex part from a design in a computer-aided design (CAD) software, e.g., without first having to design and fabricate special, e.g., insert-molding, tools or dies. Such additive-manufacturing processes can reduce or eliminate substantial intermediate delays commonly imposed by formative processes, such as, for example, injection or insert molding. As well, a component incorporating structural differences attributable to an additive-manufacturing process (which are not attainable using formative- or subtractive-manufacturing processes) can achieve one or more acoustical, electrical, structural, or other, performance-improvements compared to a component fabricated using a formative- or subtractive-manufacturing process.

The remainder of this disclosure describes aspects of additive-manufacturing processes, as well as additively manufactured components and corresponding intermediate constructs.

### II. ADDITIVE-MANUFACTURING

To illustrate selected concepts pertaining to additive manufacturing, FIGS. 7A through 7C show intermediate constructs formed using vat polymerization, a specie of additive-manufacturing processes. In a vat-polymerization process, a container (e.g., a vat) of a polymer resin can be selectively stimulated to induce polymerization (curing) within a desired region of the resin. In a typical vat-polymerization process, the polymer resin can be a so-called photopolymer (also sometimes referred to in the art as a photoreactive polymer) resin that cures (e.g., polymerizes) when illuminated by a selected wavelength of light (e.g., within an ultra-violet frequency band). Other additive-manufacturing processes induce material accretion through other mechanisms. For example, a selective-laser-sintering (SLS) process can fuse together small particles of, e.g., plastic, metal, ceramic, or glass, by heating them with a directed laser. Nonetheless, for succinctness, vat-polymerization processes are described herein as being convenient examples to illustrate disclosed principles.

In a so-called “Digital Light Projection (DLP)” implementation of a vat-polymerization process, a projector can project an image on a surface of the photopolymer (e.g., through a windowed wall of the vat) to concurrently cure all regions of the layer. A DLP process can provide a high-degree of dimensional accuracy. For example, each successively cured layer of photopolymer resin can range in thickness between about 5 microns to about 100 microns, such as, for example, between about 10 microns and about 80 microns, with between about 30 micron and about 50 microns being an example. Similarly, a DLP projector can project high-resolution images onto each layer to induce polymerization within the respective layer and with previously cured resin. By contrast, in a so-called “stereo-lithography” implementation, a laser can sequentially illuminate selected regions of a given layer to induce polymerization locally relative to the incident laser.

FIG. 7A shows a vat-polymerization tool 700 producing a part within a vat, or container, 710 of polymer resin (omitted for clarity of illustration). In FIG. 7A, a partially fabricated (cured) portion 720a of the part is shown affixed to a carrier unit 712 (sometimes referred to in the art as a “print bed”). A windowed wall 714 of the container 710 is substantially transparent to light in the bandwidth used to induce polymerization of the resin, and a projector 716 selectively illuminates a defined region 722a of the resin through the wall 714. The illuminated region 722a of the resin cures (e.g., polymerizes and bonds with an adjacent, previously cured region of the part), incrementally adding material to the partially fabricated portion 720a of the part.

In FIG. 7B, the carrier unit 712 is shown incrementally moved away from the vat wall 714 illuminated by the projector 716 (e.g., in a distal direction, relative to a direction of light emitted by the projector). In FIG. 7B, the region 722a illuminated in FIG. 7A, having already cured, has become integral with the partially fabricated portion 720a of the part shown in FIG. 7A, defining an incrementally more complete portion 720b of the part. In FIG. 7B, a further region 722b of the polymer resin is illuminated for curing. In FIG. 7C, the further region 722c (FIG. 7B) of resin has cured and become integral with the partially fabricated portion 720b of the part shown in FIG. 7B. In FIG. 7C, the carrier unit 712 is shown moved still farther away from the projector 716 and a still further region 722c of the polymer resin is shown being illuminated. The procedure of curing incremental regions of polymer resin and moving the carrier unit 712 away from the projector by a corresponding distance can continue until the part is fully fabricated.

For purposes of simplicity and clarity, the series of images shown in FIGS. 7A through 7C illustrate a monolithic block 720a, 720b, 720c of cured resin. Although known additive-manufacturing processes can produce components having much more complex geometric features than a monolithic block, they are unable to fabricate parts incorporating, e.g., non-planar, inclusions. Accordingly, when producing a prototype of a newly designed component, e.g., acoustic component, current limitations of additive-manufacturing processes require that the design be modified and, potentially, built in distinct constituent components which are subsequently glued or otherwise joined together.

For example, a microspeaker design may include a metal component embedded in a substrate. Prior additive-manufacturing processes generally required a change to a substrate's design, a metal component's design, or both, so that, after fabricating the substrate, the metal part could be press-fit or slid into place and then affixed with glue or another adhesive. Alternatively, prior additive-manufacturing processes have required, e.g., a microspeaker design to be altered to fabricate a prototype intended to validate selected functional characteristics independently of other characteristics. For example, a thickened region of the additively-manufactured substrate may have been substituted for an embedded metal part to simulate stiffness and acoustic properties, and electrical components (e.g., weld pads) can be replaced with a wired-out implementation at the prototype stage.

### III. ADDITIVE MANUFACTURING WITH AN INCLUSION

Disclosed additive-manufacturing processes, and additively manufactured components, do not suffer from such deficiencies. Suitable additive-manufacturing processes and additively manufactured components are described by way of example below.

### Selected Exposure Region, Intensity, and Duration in Vat Polymerization

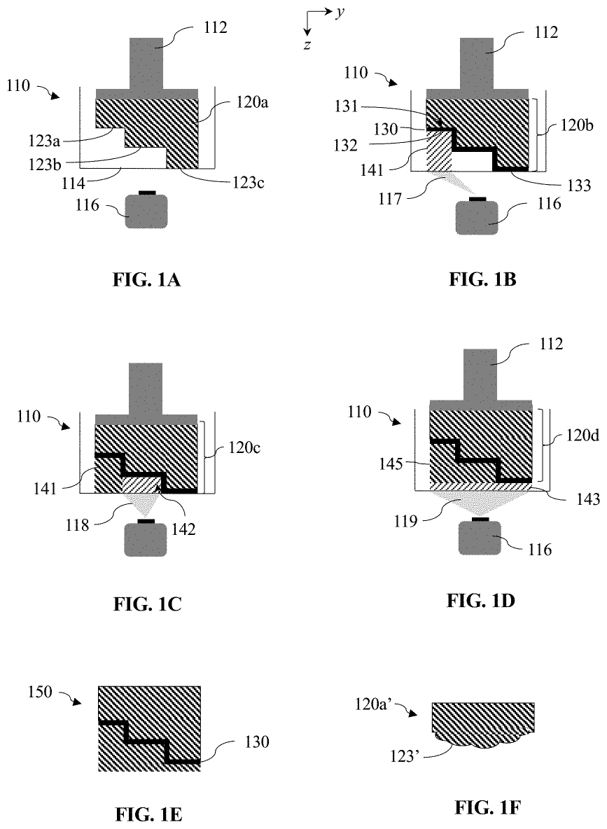

Referring now to FIGS. 1A through 1D, fabrication of a component as shown in FIG. 1E is described by way of reference to several intermediate constructs. In FIG. 1A, a partially fabricated component 120a (also referred to herein as an intermediate construct) is shown immersed in a vat 110 of a photopolymer (omitted for clarity) and affixed to a carrier platform (sometimes also referred to in the art as a “print bed”) 112. The partially fabricated component 120a is a cured substrate with a surface 123 defining a non-planar contour. In FIG. 1A, the non-planar surface 123 is shown as being a “stepped” surface composed of three planar surfaces 123a, 123b, and 123c, each corresponding to a respective elevation or distance along the z-axis from the carrier 112.

In FIG. 1B, an inclusion (e.g., a non-planar metal plate) 130 has been added to the partially fabricated component 120a, forming another intermediate construct 120b. The inclusion 130 has opposed first and second major surfaces 131, 132, and the first major surface 131 has a complementary contour relative to the non-planar surface 123 of the partially fabricated component 120a, defining a non-planar interface between the partially fabricated component 120a and the inclusion. Subsequent to curing the substrate shown in FIG. 1A, the partially fabricated component 120a has been removed from the vat 110 and the inclusion 130 shown in FIG. 1B, and more particularly the first major surface 131 of the inclusion, has been placed in an abutting relationship with the non-planar surface 123 of the partially fabricated component 120a. The first major surface 131 conforms to the non-planar surface of the partially fabricated component 120a. The second major surface 132 of the inclusion 130 also has a stepped profile similar to the non-planar surface 123 shown in FIG. 1A.

Also depicted in FIG. 1B is a first column 141 of the photopolymer extending from an illuminable wall 114 of the vat 110 to a corresponding elevated surface 132 of the inclusion 130. In FIG. 1B, the projector 116 is projecting a first image on the wall 114, exposing the first column 141 of the photopolymer to light having a selected intensity and wavelength corresponding to a “thickness” of the first column 141 (i.e., a distance from an interior surface of the vat wall 114 and the elevated surface 132 of the inclusion). In FIG. 1B, the projected image 117 corresponds to a desired cross-sectional shape of the first column 141.

Turning now to FIG. 1C, the first column 141 (FIG. 1B) has cured and is an integral region of the partially fabricated component 120c shown in FIG. 1C. In FIG. 1C, a second column 142 of the photopolymer extends from the illuminable wall 114 to a corresponding second elevated surface of the inclusion 130. In FIG. 1B, the projector 116 is projecting a second image on the wall 114, exposing the second column 142 of the photopolymer to light having a selected intensity and wavelength corresponding to a “thickness” of the second column 142 (i.e., a distance from an interior surface of the vat wall 114 and the second elevated surface of the inclusion 130). In FIG. 1C, the projected image 118 corresponds to a desired cross-sectional shape of the second column 142.

In FIGS. 1B and 1C, a region 133 of the inclusion 130 contacts or is positioned in close proximity to the illuminable wall 114 of the vat 110, inhibiting polymerization of photopolymer adjacent the region 133. Thus, in FIGS. 1B and 1C, the first column and the second column constitute respective regions of a single “layer” of accreted material. Stated differently, the first column 141 and the second column 142 together define a composite layer 145 (FIG. 1D) of the substrate 120d, and the composite layer has a non-uniform layer thickness along the z-axis.

The first column 141 and the second column 142 are depicted in FIGS. 1B and 1C as being exposed (illuminated) sequentially. Nonetheless, the exposures can occur concurrently, e.g., with each column being exposed to a respective intensity of light. Alternatively, the exposure of each column can occur during overlapping durations, though each exposure may begin or end, or begin and end, at different times. Regardless, a variation in thickness of the non-uniformly thick layer 145, for example, can range from about 5 microns to about 100 microns, such as, for example, between about 10 microns and about 80 microns, with between about 30 micron and about 50 microns being an example.

In FIG. 1D, the carrier 112 has incrementally moved the partially fabricated component away from the wall 114 of the vat 110. A uniformly thick layer 143 of photopolymer is positioned between the partially fabricated component 120d, 130 and the wall 114, and the projector 116 illuminates the layer 143 to cure the uniformly thick layer. A thickness of the uniformly thick layer, for example, can range in thickness from about 5 microns to about 100 microns, such as, for example, between about 10 microns and about 80 microns, with between about 30 micron and about 50 microns being an example. The image 119 projected through the wall 114 corresponds to a desired cross-sectional configuration for the layer 143.

FIG. 1E schematically illustrates an additively manufactured component 150 having a non-planar inclusion 130 as described above. In FIG. 1E, the layer 143 of photopolymer undergoing exposure in FIG. 1D has cured, and the part 150 has been removed from the vat 110. The inclusion 130 can be a metal member, e.g., a formatively manufactured (e.g., stamped) metal component. Although shown in FIG. 1E as extending entirely across the substrate, the inclusion 130 can have a first portion encapsulated by the substrate. A second portion of such an inclusion can be exposed at the external surface of the substrate, as with the illustrated inclusion.

Although the surface 123 in FIG. 1A is illustrated as being stepped and having planar surfaces 123a, 123b, and 123c oriented orthogonally relative to the z-axis and parallel to the y-axis, the surface 123 (or any of the constituent surfaces 123a, 123b, and 123c) can be curved or sloped (e.g., oriented transversely relative to the y-axis). By way of example, FIG. 1E illustrates an intermediate construct 120a′ having a non-planar surface 123′ defining a curved contour. The curved surface 123′ can be “organic” (e.g., smoothly contoured within the resolution of the additively manufactured process). The inclusion 130 shown in FIGS. 1B through 1E can be similarly curved to mate with the curved surface 123′. For succinctness, several non-planar, “stepped” surfaces and complementarily contoured inclusions are described throughout the following sections. Nonetheless, it shall be understood that those surfaces and inclusions can have curved or sloped, rather than stepped, contours.

### Plural Exposure Directions in Vat Polymerization

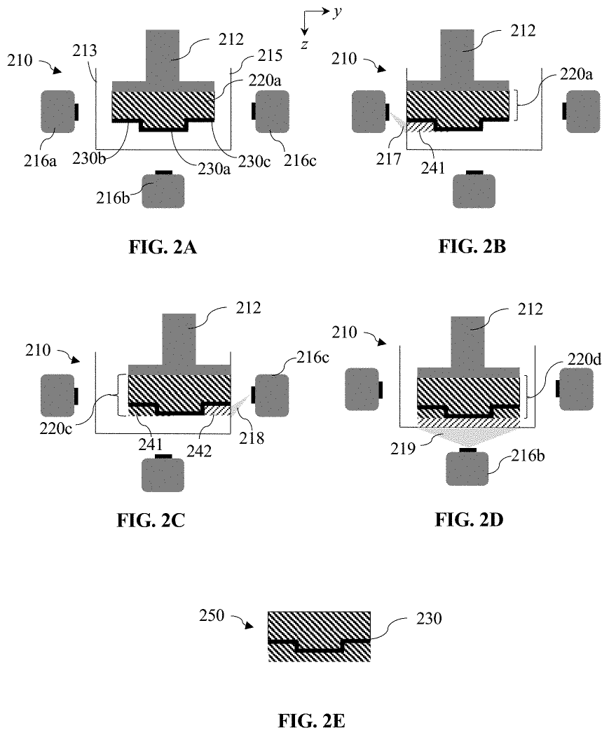

Referring now to FIGS. 2A through 2D, fabrication of the component 250 shown in FIG. 2E is described. In FIG. 2A, a partially fabricated component is shown immersed in a vat 210 of a photopolymer (omitted for clarity) and affixed to a carrier platform 212. The partially fabricated component includes a cured substrate 220a having a non-planar surface. In FIG. 2A, the contour of the non-planar surface is shown as a “stepped” surface, e.g., having three planar surfaces, each corresponding to a respective elevation. Unlike the intermediate construct shown in FIG. 1A, the construct in FIG. 2A has a platform-like central surface 230a laterally flanked by recessed outer surfaces 230b, 230c.

In FIG. 2A, an inclusion (e.g., a metal plate) 230 has been added to the cured resin 220a. As with the inclusion 130 shown in FIG. 1B, the inclusion in FIG. 2A has opposed first and second major surfaces, with the first major surface abutting the cured resin 220a as described in relation to the inclusion 130 described above. The first major surface of the inclusion 230 conforms to the non-planar contour of the cured resin 220a. The second major surface of the inclusion 230 also has a stepped profile.

In FIG. 2B a first column 241 of the photopolymer fills a region recessed from the central surface 230a. The carrier 212 is displaced along the y-axis from the neutral position shown in FIG. 2A to a side-exposure position, placing the intermediate construct into close proximity to or contact with a transparent sidewall 213 of the vat 210. A corresponding side projector 216a projects a first image 217 on the side wall 213, exposing the first column 217 to light having a selected intensity and wavelength suitable to cure the volume and arrangement of the first column.

Turning now to FIG. 2C, the first column 241 (FIG. 2B) has cured and is an integral region of the partially fabricated component 220c shown in FIG. 2C. In FIG. 2C, the carrier 212 is displaced from the neutral position shown in FIG. 2A to a second side-exposure position (e.g., opposite the side-exposure position shown in FIG. 2B), placing the intermediate construct into close proximity or contact with a second transparent sidewall of the vat 210. A corresponding second side projector 216c projects a second image 218 on the side wall 215, exposing the second column 242 to light having a selected intensity and wavelength suitable to cure the volume and arrangement of the second column.

The first column 241 and the second column 242 constitute respective regions of a “layer” of accreted material at a common elevation. However, unlike the first and second columns 141, 142 shown in FIGS. 1B and 1C, the central platform 230a extends between the first column 241 and the second column 242. Thus, the first column 241 and the second column 242 do not necessarily define a composite layer of the substrate.

The first and the second columns 241, 242 have a thickness that can range along the z-axis from about 5 microns to about 100 microns, such as, for example, between about 10 microns and about 80 microns, with between about 30 micron and about 50 microns being an example.

Although a first projector 216a and a second projector 216c are shown in FIGS. 2B and 2C, contemplated additive-manufacturing tools have more or fewer side projectors. For example, a single, movable projector (not shown) can serve the purposes of the first projector 216a, and can be moved into the position shown occupied by the second projector 216c, or vice-versa.

In FIG. 2D, the carrier 212 has moved the partially fabricated component 220d into a suitable proximity of a “lower” the wall 214 of the vat 210 for exposing a uniformly thick layer 243 of photopolymer to cure the layer. A thickness of the uniformly thick layer, for example, can range in thickness from about 5 microns to about 100 microns, such as, for example, between about 10 microns and about 80 microns, with between about 30 micron and about 50 microns being an example.

FIG. 2E schematically illustrates an additively manufactured component 250 having a non-planar inclusion 230. In FIG. 2E, the layer 243 of photopolymer undergoing exposure in FIG. 2D has cured, and the part 250 has been removed from the vat 210. The illustrated inclusion 230 has opposed edges exposed to at an external surface of the component 250. Although shown in FIG. 2E as extending entirely across the substrate with opposed edges exposed to an external surface, the inclusion 230 can have a first portion, e.g., a first edge encapsulated by the substrate. A second portion, e.g., a second edge, of such an inclusion can be exposed at the external surface of the substrate, as with the illustrated inclusion 230.

### Overhead Curing

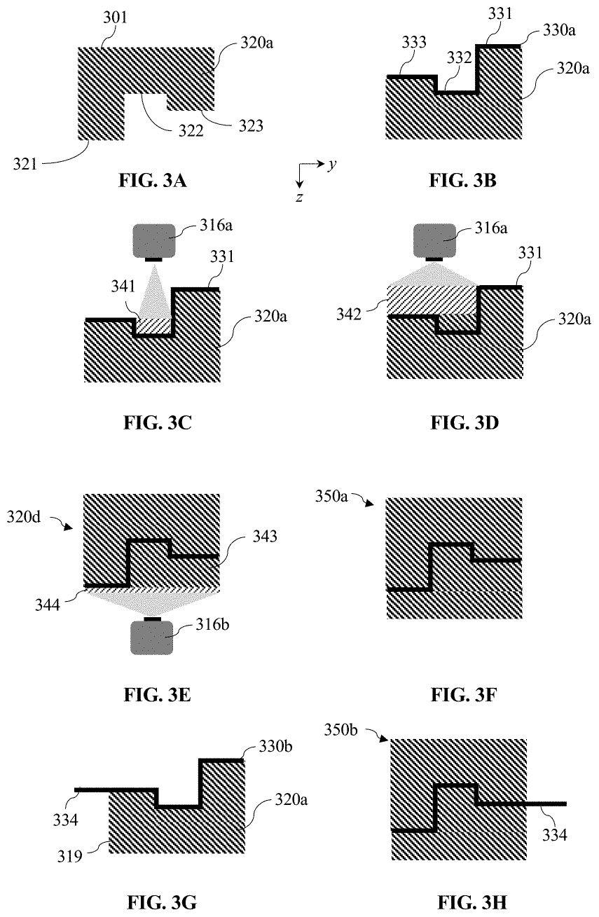

Referring now to FIGS. 3A through 3E, fabrication of the components shown in FIGS. 3F and 3H is described. In FIG. 3A, a partially fabricated component 320 is shown after removal from in a vat of a photopolymer. Like the partially fabricated components shown in FIGS. 1A through 1D and 2A though 2D, the partially fabricated component 320 is affixed to a carrier platform (omitted for clarity) adjacent the surface 301. The partially fabricated component 320 includes a cured substrate 320a having a non-planar surface. In FIG. 3A, the non-planar surface is shown as a “stepped” surface composed of three planar surfaces 321, 322, 323, each corresponding to a respective elevation in the z-direction. Unlike the intermediate constructs shown in FIGS. 1A and 2A, the construct 320 in FIG. 3A has a central surface 322 laterally flanked by and recessed from outer surfaces 321, 323.

In FIG. 3B, an inclusion (e.g., a metal plate) 330 has been added to the cured resin 320a. As with the inclusions 130, 230 shown in FIGS. 1B and 2B, the inclusion in FIG. 3B has opposed first and second major surfaces and is assembled with the cured resin as described above. In FIG. 3B, the first major surface of the inclusion conforms to the non-planar surface 321, 322, 323 of the cured resin 320a. The second major surface 331, 332, 333 of the inclusion 330 also has a stepped profile similar to the non-planar surface 321, 332, 333, as shown in FIG. 3B.

In FIG. 3B, the intermediate construct 320a, 330 is removed from the vat and rotated 180-degrees around an axis oriented orthogonally to the y-z plane.

In FIG. 3C, a first column 341 of a photopolymer (the same as or different from the polymer used in the substrate 320a) fills the recessed region adjacent the central surface 332. The illustrated first column 341 has a thickness equal to a depth of the recessed region 332 compared to the lower of the flanking outer surfaces 331, 333. An overhead projector 316a illuminates the first column 341 and induces curing of the first column. Subsequently, as FIG. 3D shows, a second column 342 of photopolymer can be applied over the lower of the laterally flanking surfaces 331, 333 and the cured first column 341, and illuminated by an image emitted by the overhead projector 316a. The first and the second columns 341, 342 have a thickness that can range from about 5 microns to about 100 microns, such as, for example, between about 10 microns and about 80 microns, with between about 30 micron and about 50 microns being an example.

After curing, the first column 341 and the second column 342 constitute respective regions of an integral “layer” 343 (FIG. 3E) of accreted material. The intermediate construct 320d can again be rotated 180-degrees around the axis oriented orthogonally to the y-z plane, as shown in FIG. 3E. In FIG. 3E, the print bed (not shown) has positioned the intermediate construct 320d, and more particularly a surface of the layer 343, into a suitable proximity of a “lower” the wall of the vat (not shown) for exposing a uniformly thick layer 344 of photopolymer to cure the layer with an image projected by the projector 316d. A thickness of the uniformly thick layer 344, for example, can range in thickness from about 5 microns to about 100 microns, such as, for example, between about 10 microns and about 80 microns, with between about 30 micron and about 50 microns being an example.

FIG. 3F schematically illustrates an additively manufactured component 350a having a non-planar inclusion 330a. In FIG. 3F, the layer 344 of photopolymer undergoing exposure in FIG. 3E has cured, and the part 350a has been removed from the vat.

Referring further to FIGS. 3B and 3G, fabrication of the component shown in FIG. 3H is described. The inclusion 330a shown in FIG. 3B lies within an outer boundary defined by the cured-resin substrate 320a. By contrast, the inclusion 330b shown in FIG. 3G has a cantilevered portion 334 extending beyond an outer surface 319 of the cured-resin substrate 320a. The intermediate construct shown in FIG. 3G can be substituted for the intermediate construct shown in FIG. 3B and can undergo additive-manufacturing process operations as described in relation to FIGS. 3C, 3D, 3E, and 3F, arriving at the alternative additively-manufactured component 350b shown in FIG. 3H. As shown in FIG. 3H, the cantilevered portion 334 extends beyond an outer surface of the component 350b. Although shown in FIG. 3F and FIG. 3G as extending entirely across the substrate, each respective inclusion 330a, 330b can have a first portion encapsulated by the substrate. A second portion of such an inclusion can be exposed at the external surface of the substrate, as with the illustrated inclusion.

### Inclusion Filling after Vat Polymerization

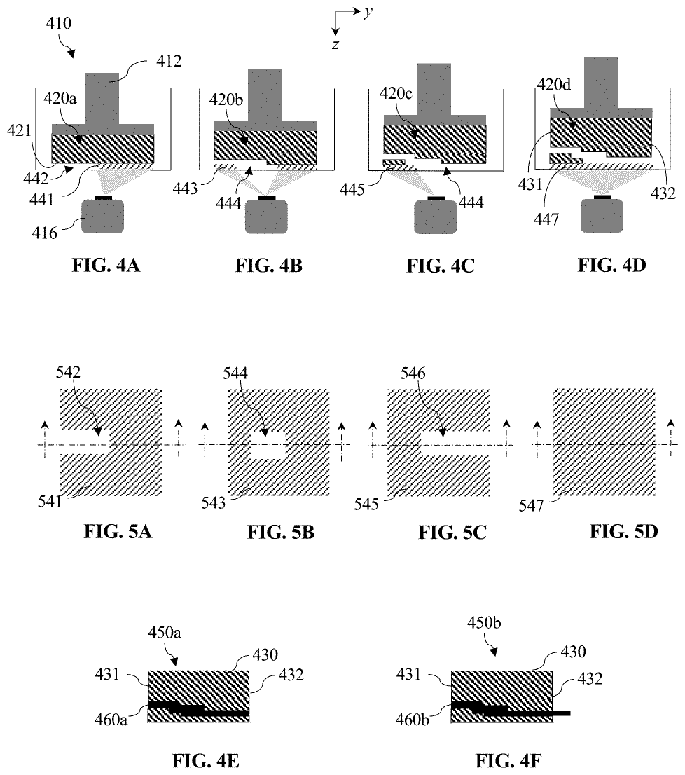

Referring now to FIGS. 4A through 4D and corresponding FIGS. 5A through 5D, fabrication of components as shown in FIG. 4E and FIG. 4F is described. FIGS. 5A through 5D show regions of the lower vat wall 414 illuminated by the projector 416 in each of FIGS. 4A through 4D, respectively. Each of FIGS. 4A through 4D illustrates a side-elevation view of a cross-section through the vat-polymerization tool 410 and each respective intermediate construct, as taken along the section lines shown in FIGS. 5A through 5D, respectively.

In FIG. 4A, a partially fabricated component 420a is shown immersed in a vat 410 of a photopolymer (omitted for clarity) and affixed to a print bed 412. The partially fabricated component 420a includes a cured-resin substrate having a planar surface 421 adjacent to and spaced from the lower wall 414 of the vat 410. In FIG. 4A, photopolymer fills the gap positioned between the cured-resin substrate 420a and the lower-wall 414. A U-shaped region 541 of the lower wall 414 is illuminated, as depicted in FIG. 5A, curing a corresponding U-shaped region 441 of the photopolymer and leaving a region 442 of the photopolymer uncured.

Subsequent to curing the U-shaped region 441 of the photopolymer shown in FIG. 4A, the print bed 412 moves the partially fabricated component 420b (FIG. 4B) away from the lower wall 414, defining a gap between the partially fabricated component 420b and the lower wall 414. In FIG. 4B, photopolymer fills the gap positioned between the partially fabricated component 420b and the lower-wall 414. A perimeter region 543 of the lower wall 414 is illuminated, as depicted in FIG. 5B, leaving an interior region 544 of the wall unexposed, curing a corresponding perimeter region 443 of the photopolymer and leaving an interior region 444 of the photopolymer uncured. The uncured region 444 in FIG. 4B overlaps with the uncured region 442 in FIG. 4A, defining an open inclusion spanning plural elevational layers within the partially fabricated component 420c (FIG. 4C).

Subsequent to curing the perimeter region 443 of the photopolymer shown in FIG. 4B, the print bed 412 moves the partially fabricated component 420c (FIG. 4C) away from the lower wall 414, defining a gap between the partially fabricated component 420c and the lower wall. In FIG. 4C, photopolymer fills the gap and open inclusion, and a U-shaped region 545 of the lower wall 414 is illuminated, as depicted in FIG. 5C, curing a corresponding U-shaped region 445 of the photopolymer and leaving a region 446 of the photopolymer uncured. The uncured region 446 in FIG. 4C overlaps with the uncured region 444 in FIG. 4B, extending the open inclusion to, in this example, a third elevational layer within the partially fabricated component 420d (FIG. 4D), as well as from a first side wall 431 to an opposed second side wall 432 of the partially fabricated component 420d. In FIG. 4D, the print bed 412 has moved the partially fabricated component 420d away from the lower wall 414, defining a gap filled with photopolymer. To enclose the inclusion and define an enclosed, internal channel extending through the partially fabricated component 420d, all of the photopolymer within the gap that overlaps with the open inclusion is illuminated and cured, as depicted by the illuminated region 547 shown in FIG. 5D.

In FIG. 4E and FIG. 4F, the cured-resin substrate 430 has been removed from the vat and a molten or softened material (e.g., an electrically conductive material, e.g., copper) has been injected into the channel defined by the overlapping uncured regions 442, 444, 446. The molten or softened material can solidify or otherwise harden, defining a non-planar inclusion 460a, 460b embedded within an additively manufactured substrate 430. In FIG. 4E, the inclusion 460a extends from a first outer wall to a second (e.g., opposed) outer wall. In FIG. 4E, the inclusion 460b extends from the first outer wall, through the additively manufactured substrate 430, and beyond a second (e.g., opposed) outer wall, defining a cantilevered member extending outward from the substrate.

### Vat Polymerization and Material Deposition

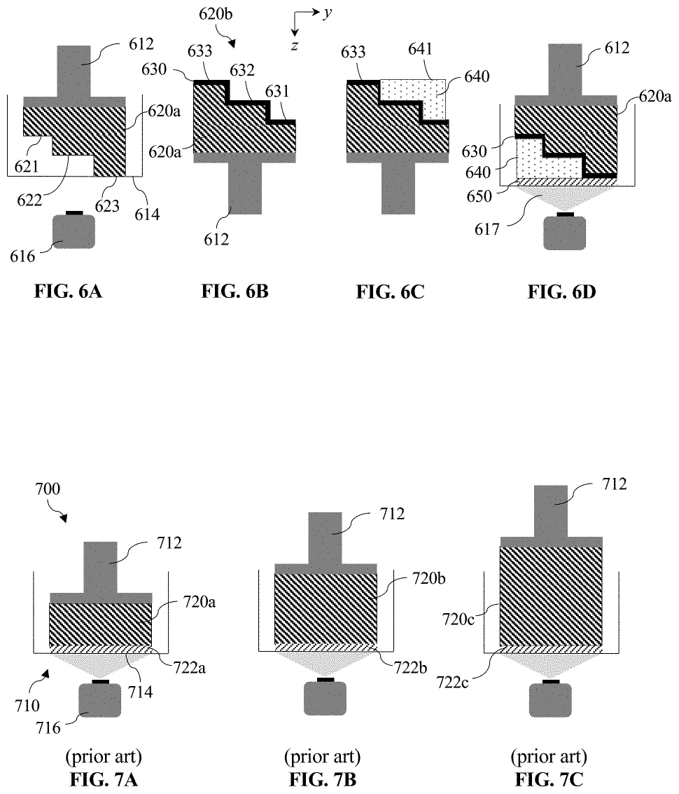

Alternative approaches for additively fabricating substrates with non-planar inclusions are described in relation to FIGS. 6A through 6D. FIG. 6A depicts a partially fabricated component 6201 having a “stepped” surface composed of three planar surfaces 621, 622, 623, as with the substrate 120a in FIG. 1A. The partially fabricated component 620a is connected to a print bed 612 in a vat polymerization tool 610, and in FIG. 6B, the partially fabricated component 620a and print bed 612 have been rotated 180-degrees about an axis extending orthogonally to the y-z plane. For example, the partially fabricated component and print bed can be rotated through a desired angle about a desired axis, e.g., by 180 degrees about the illustrated x-axis, as shown in FIG. 6B. Prior to rotating the partial component and print bed, the partially fabricated component can be removed from the print bed. A similar approach to orienting a partially fabricated component (and print bed) can be applied prior to filling and curing a pocket within a partially fabricated component (e.g., as shown and described in relation to FIGS. 3A through 3H).

In FIG. 6B, an inclusion (e.g., a formatively manufactured metal plate) 630 has been added to the partially fabricated component 620a, forming another intermediate construct 620b. In FIG. 6B, the inclusion 630 conforms to the non-planar surface 621, 622, 623 of the partially fabricated component 620a. The second major surface of the inclusion 630 also has a stepped profile defining a non-planar surface 631, 632, 633.

In FIG. 6C, a second inclusion member 640 mates with the non-planar surface 631, 632, 633. In an embodiment, the second inclusion member 640 comprises an additively manufactured accretion of material (e.g., a metal or a non-metal) at least partially encapsulating the non-planar inclusion 630 between the cured substrate 620a and a region of the second inclusion member. The material may be the same as or different from the material of which the substrate 620a is formed. In another embodiment, the second inclusion member 630 comprises a separately manufactured insert having a contour complementing the contour of the non-planar surface 631, 632, 633. In both embodiments, the second inclusion member can define a surface 641 being co-planar with the surface 633 of the intermediate construct 620b shown in FIG. 6B.

As noted above, the second inclusion member 640 can comprise an additively manufactured accretion of material. The accretion of material can be fabricated using an approach as described in relation to FIGS. 1A through 1D, or can be fabricated using a material-deposition process. For example, material-deposition processes suitable for such material accretion include, for example, material jetting processes, fused-filament-fabrication processes, and fused-deposition modeling processes. Such material-deposition processes can selectively control thickness within a non-planar region (e.g., over the non-planar surface 631, 632, 633). A deposition-fabricated, non-planar region can have a variation in thickness greater than about 100 microns, as a “print head” that deposits the material can selectively move in three dimensions. Selective-laser-sintering processes also can be well-suited for filling a non-planar region adjacent the non-planar surface 631, 632, 633.

In FIG. 6D, the intermediate construct 620c (FIG. 6C) has been rotated a further 180-degrees about the axis extending orthogonally to the y-z plane and returned to a vat-polymerization tool 610 to undergo further additive-manufacturing processes. For example, the co-planar surfaces 641, 633 can be spaced from the lower wall 614 of the vat and a layer 650 of photopolymer can fill the gap between the intermediate construct 620c and the vat wall 614. In FIG. 6D, the projector 616 illuminates the photopolymer layer 650 for further curing.

### IV. STRUCTURAL FEATURES OF ADDITIVELY FABRICATED COMPONENTS

Components fabricated using additive-manufacturing processes described herein materially differ in structure from components fabricated using prior additive-manufacturing processes, or formative- or subtractive-manufacturing processes. For example, unlike subtractive or formative manufacturing processes, disclosed additive-manufacturing processes can produce complex component features within a substrate having a unitary (e.g., continuous) construction. For example, a component having an included cavity (e.g., a sealed cavity) or a deep recess can be produced from a unitary, continuous material using an additive-manufacturing process without requiring any secondary manufacturing operations. Such a component may be made of a homogenous material, e.g., a material having an isotropic material strength or a material having an anisotropic material strength. As yet another example, an additive-manufacturing process can fabricate a hollow spheroid (or other undercut structures) by selectively adding material to define features of the structure, e.g., a thin-walled, spherical shell in the case of a hollow spheroid.

For example, a rigid metal-stamped electrical connections and screw tabs can be at least partially embedded in an additively manufactured substrate. Such a component can be true to an original design, as opposed to a modified design suitable for manufacturing by a formative or a subtractive process. As well or alternatively, such a component can retain a desired functionality without requiring additional processes, e.g., joining processes, such as, for example, soldering a lead wire on an insert to form an electrical connection, or gluing a metal piece to a substrate to enhance rigidity.

By contrast, a subtractive process or a formative process (e.g., milling, or injection molding) may require subsequent assembly or a joining process to produce a component having a complex geometry. And, the subsequent assembly or joining process would leave a remnant (e.g., a seam or other internal discontinuity) within the component. For example, to produce a hollow spheroid using a formative- or a subtractive- process, a pair of hemispherical shells can be fabricated. The pair of shells can subsequently be brought into alignment with each other and joined (e.g., welded, bonded, glued) together. Each hemisphere of the resulting hollow spheroid can be formed of a substantially continuous material, but the joining process would leave a seam or other discontinuity at the interface between the opposing hemispheres. Such a seam would be lacking if the spheroid were fabricated using an additive-manufacturing process.

Additional examples of structural differences from formative- or subtractive-manufacturing processes can include, for example, a continuous substrate having anisotropic bulk properties (e.g., material strength or stiffness); a substrate formed of a light-curable polymer; a presence of so-called “undercuts” or other non-toolable structural features, with or without a encased inclusion; a lack of carrier tabs, seams (e.g., welded or glued joints), or other indicia of formative- or subtractive-manufacturing processes, such as, for example, part lines, drafts, sink marks, and imperfections left from slides and gates; an inclusion positioned within a continuous substrate; a sealed cavity or other recess; a presence of an indicia of an additive-manufacturing process, such as, for example, a pattern of surface imperfections corresponding to a particular process, e.g., a vat-polymerization process; a unitary substrate having smoothly contoured interior surfaces, including, for example, surfaces having a selected “organic” (e.g., smoothly contoured) curvature to reduce or to eliminate flow separation or recirculation (e.g. a C2-surface, where the first- and second-derivatives are continuous, or a C3-surface, where the first, second, and third derivatives are continuous); a substrate having “thin” walls, e.g., less than about 0.4 mm, such as, for example, between about 50 micron to about 350 micron, e.g., between about 100 micron and about 250 micron; or a combination of one or more of the preceding indicia of a component fabricated using an additive-manufacturing process.

As well, a component incorporating one or more of the foregoing or other structural differences attributable to an additive-manufacturing process (which are not attainable using formative- or subtractive-manufacturing processes) can achieve one or more acoustical, electrical, or structural performance-improvements compared to a component fabricated using a formative- or subtractive-manufacturing process.

### V. ELECTRONIC DEVICES INCORPORATING ADDITIVELY MANUFACTURED COMPONENTS

An electronic component or device (e.g., an electro-acoustic transducer, a media appliance, a wearable electronic device, a laptop computer, a tablet computer, etc.) can incorporate an additively fabricated component as described herein. Electronic devices, including those incorporating additively manufactured components of the type described above, are described by way of reference to a specific example of an audio appliance. Electronic devices represent but one possible class of computing environments which can incorporate additively manufactured components, as described herein. Nonetheless, electronic devices are succinctly described in relation to a particular audio appliance 190 to illustrate an example of a system incorporating and benefitting from an additively manufactured component.

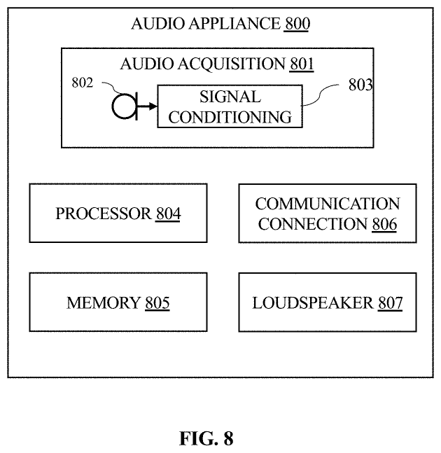

As shown in FIG. 8, an audio appliance 190 or other electronic device can include, in its most basic form, a processor 194, a memory 195, and a loudspeaker or other electro-acoustic transducer 197, and associated circuitry (e.g., a signal bus, which is omitted from FIG. 19 for clarity). The memory 195 can store instructions that, when executed by the processor 194, cause the circuity in the audio appliance 190 to drive the electro-acoustic transducer 197 to emit sound (e.g., to cause a diaphragm to oscillate) over a selected frequency bandwidth. The electro-acoustic transducer 197 can include, for example, an additively manufactured diaphragm having a wholly or partially embedded, non-planar inclusion as described herein.

The audio appliance 190 schematically illustrated in FIG. 8 also includes a communication connection 196, as to establish communication with another computing environment. As well, the audio appliance 190 includes an audio acquisition module 191 having a microphone transducer 192 to convert incident sound to an electrical signal, together with a signal conditioning module 193 to condition (e.g., sample, filter, and/or otherwise condition) the electrical signal emitted by the microphone. In addition, the memory 195 can store other instructions that, when executed by the processor, cause the audio appliance 190 to perform any of a variety of tasks akin to a general computing environment.

### VI. OTHER EXEMPLARY EMBODIMENTS

The examples described above generally concern principles relating to additively manufactured components having one or more non-planar inclusions, together with principles relating to associated methods for producing such components, as well as systems including such components.

The previous description is provided to enable a person skilled in the art to make or use the disclosed principles. Embodiments other than those described above in detail are contemplated based on the principles disclosed herein, together with any attendant changes in configurations of the respective apparatus or changes in order of method acts described herein, without departing from the spirit or scope of this disclosure. Various modifications to the examples described herein will be readily apparent to those skilled in the art.

For example, certain embodiments are described above in connection with a particular species of additive-manufacturing process, e.g., vat-polymerization. Within that species of additive manufacturing processes, disclosed principles are described in relation to DLP processes for succinctness and clarity. Nonetheless, disclosed principles are not so limited. Rather, disclosed principles may be practiced or embodied in components produced using any of a variety of additive-manufacturing processes, including, for example, powder-bed fusion processes, binder jetting processes, material extrusion processes, directed-energy deposition processes, sheet-lamination processes, and combinations thereof.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by reference in its entirety for all purposes.

And, those of ordinary skill in the art will appreciate that the exemplary embodiments disclosed herein can be adapted to various configurations and/or uses without departing from the disclosed principles. Applying the principles disclosed herein, it is possible to provide a wide variety of additively manufactured components. For example, the principles described above in connection with any particular example can be combined with the principles described in connection with another example described herein. Thus, all structural and functional equivalents to the features and method acts of the various embodiments described throughout the disclosure that are known or later come to be known to those of ordinary skill in the art are intended to be encompassed by the principles described and the features and acts claimed herein. Accordingly, neither the claims nor this detailed description shall be construed in a limiting sense, and following a review of this disclosure, those of ordinary skill in the art will appreciate the wide variety of liquid-resistant electronic devices, electro-acoustic transducers, and modules, as well as related systems, that can be devised under disclosed and claimed concepts.

Moreover, nothing disclosed herein is intended to be dedicated to the public regardless of whether such disclosure is explicitly recited in the claims. To aid the Patent Office and any readers of any patent issued on this application in interpreting the claims appended hereto or otherwise presented throughout prosecution of this or any continuing patent application, applicants wish to note that they do not intend any claimed feature to be construed under or otherwise to invoke the provisions of 35 USC 112(f), unless the phrase “means for” or “step for” is explicitly used in the particular claim.

The appended claims are not intended to be limited to the embodiments shown herein, but are to be accorded the full scope consistent with the language of the claims, wherein reference to a feature in the singular, such as by use of the article “a” or “an” is not intended to mean “one and only one” unless specifically so stated, but rather “one or more”.

Thus, in view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in any claims presented anytime throughout prosecution of this application or any application claiming benefit of or priority from this application, and more particularly but not exclusively in the claims appended hereto.

1. A component, comprising:
an additively manufactured substrate having a first region defining a corresponding first internal contour and a second region defining a corresponding second internal contour, wherein one or both of the first internal contour and the second internal contour is non-planar; and
an inclusion positioned within the substrate between the first region and the second region, wherein the inclusion has a first major surface and a second major surface, wherein the first major surface of the inclusion conforms to the first internal contour of the substrate, the second major surface of the inclusion conforms to the second internal contour of the substrate, or combinations thereof.

2. The component according to claim 1, wherein the substrate is a unitary construct including the first region and the second region.

3. The component according to claim 2, wherein the unitary construct comprises a homogeneous material spanning from the first region to the second region.

4. The component according to claim 1, wherein the additively manufactured substrate has an isotropic material strength spanning from the first region to the second region.

5. The component according to claim 1, wherein the additively manufactured substrate comprises a homogeneous material spanning from the first region to the second region.

6. The component according to claim 5, wherein the homogeneous material has an anisotropic material strength.

7. The component according to claim 1, wherein the inclusion comprises a cavity positioned within the substrate.

8. The component according to claim 7, wherein the substrate sealably encloses the cavity.

9. The component according to claim 7, wherein substrate defines an external surface and a channel extending from the external surface of the substrate to the cavity.

10. The component according to claim 1, wherein the inclusion comprises a member positioned within and at least partially retained by the additively manufactured substrate.

11. The component according to claim 10, wherein the additively manufactured substrate encapsulates at least a portion of the member.

12. The component according to claim 1, wherein the substrate defines an external surface and the inclusion comprises a metal member having a first portion and a second portion, wherein the substrate encapsulates the first portion and exposes the second portion at the external surface of the substrate.

13. The component according to claim 1, wherein the inclusion comprises a first member and a second member.

14. The component according to claim 13, wherein the first member comprises a formatively manufactured metal member, and wherein the second member comprises a non-metal member.

15. A component, comprising:
an additively manufactured substrate; and
an inclusion member having a non-planar region embedded within at least a portion of the additively manufactured substrate, wherein an interface between the additively manufactured substrate and the non-planar region of the inclusion member is non-planar.

16. The component according to claim 15, wherein at least a portion of the non-planar region of the inclusion member embedded within the substrate comprises a metal.

17. The component according to claim 15, wherein at least a portion of the non-planar region of the inclusion member embedded within the substrate comprises a subtractively manufactured component, a formatively manufactured component, or a combination thereof.

18. The component according to claim 15, wherein the non-planar interface defines a step-wise contour, a smoothly curved contour, or a combination thereof.

19. The component according to claim 15, wherein the additively manufactured substrate comprises a first material and wherein the inclusion member comprises a second material different from the first material.

20. An electronic device, comprising:
an enclosure, a processor, and a memory, wherein the memory stores instructions executable by the processor;
an additively manufactured substrate positioned within the enclosure; and
an inclusion member having a region at least partially encapsulated within the additively manufactured substrate, wherein the encapsulated region of the inclusion member has a non-planar contour.

21. The electronic device according to claim 20, wherein the substrate defines a unitary construct at least partially encapsulating the inclusion member.

22. The additively manufactured component according to claim 20, wherein the substrate defines an external surface and the encapsulated region of the inclusion member is a first region of the inclusion member, wherein the inclusion member comprises a second region exposed at the external surface of the substrate.

23. The additively manufactured component according to claim 15, wherein the inclusion member comprises a first constituent member and a second constituent member.

24. The additively manufactured component according to claim 23, wherein the first constituent member comprises a formatively manufactured or a subtractively manufactured metal member, and wherein the second constituent member comprises a non-metal member.

25. The electronic device according to claim 20, further comprising an electro-acoustic transducer having a diaphragm, wherein the additively manufactured substrate constitutes a portion of the diaphragm and the inclusion member comprises a metal component.

26. The electronic device according to claim 25, wherein the instructions, when executed by the processor, cause the electronic device to induce oscillatory movement of the diaphragm.
